(19) United States
(12) Patent Application Publication
(10) Pub. No.: US 2008/0077315 A1
(43) Pub. Date: Mar. 27, 2008

(54) AUTOMATIC UPDATE SYSTEM, AUTOMATIC UPDATING METHOD, AND PROGRAM THEREFOR

(75) Inventor: Enjian Yao, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, TOKYO (JP)

(21) Appl. No.: 11/939,011

(22) Filed: Nov. 13, 2007

(30) Foreign Application Priority Data
Jan. 20, 2006 (JP) 2006-313239

(51) Int. Cl. G08G 1/00

(52) U.S. Cl. 701/117

(57) ABSTRACT

An automatic update system is provided that is capable of constantly maintaining a current historical database with high accuracy status by automatically updating the historical database. The automatic update system includes: a raw data saving unit for obtaining position information of a vehicle and saving the information in a raw data storage unit; a data conversion unit for calculating a link travel time of the vehicle and saving the link travel time of the vehicle in an intermediate result storage unit; and an historical database update unit for checking a number of data of the link travel time saved in the intermediate result storage unit, calculating the average value of the link travel time when the number is equal to or higher than a predetermined number of data for generating a reliable database, and updating an historical database using the average value.

### CROSS-REFERENCE TO RELATED PATENT APPLICATION

This application claims the benefit of priority from Japanese Patent Application No. 2006-313239, filed on Nov. 20, 2006 in the Japanese Patent Office, the disclosure of which is incorporated herein in its entirety by reference.

### BACKGROUND

1. Technical Field

Systems and methods consistent with the present invention relate to an automatic update system, and more specifically to an automatic update system for a road link travel time historical database.

2. Description of the Related Art

A travel time historical database for each road link generated by previously collected probe data is the basis of a path search and travel time estimating process. It is considered that the accuracy of the path search and the travel time estimation depends on the extent to which the link travel time historical database reflects the basic situations (e.g., periodical change patterns depending on a season, a day of the week, a time period, etc.) of road traffic.

Based on a statistical learning theory, a periodical change pattern of traffic situations depending on a season, a day of the week, a time period (for example, with 5-minute to 1-hour interval), etc. is extracted from each piece of the accumulated link travel time data, and is saved in a link travel time historical database. Information in link travel time historical databases is maintained as the database is first generated by data accumulated in advance, unless it is manually updated later.

After the initial generation of the link travel time historical database, the database can reflect the periodical fluctuation of traffic situations with a season, a day of the week, and a time period during the initial stay. However, it cannot reflect the intermediate or long term fluctuation of road traffic situations depending on the trip pattern and the traffic volume, which result from changes of road conditions (a change of a road network, a change of road restrictions, etc.), a change of a rate of car ownership, a social and economic development, etc. This is because the data in the database is not updated after the generation. Unless the link travel time historical database is updated, the basic situations of the actual road traffic cannot be reflected as time passes. When a large difference from actual traffic situations occurs, the degradation in accuracy in road travel time estimation based on the link travel time historical database and path search is inevitable.

To address the above-mentioned problems, and others, it is necessary to analyze probe raw data that is collected at predetermined time intervals, and to manually update the link travel time historical database using the result of such an analysis. However, because the operation of updating and maintaining a database requires troublesome processes such as cleansing unnecessary data and analyzing a series of data, it is inefficient to perform such updates and maintenance. For the reasons described above, in typical conventional probe systems, which collect and use probe information, link travel time historical databases have not been updated after they are first generated.

Furthermore, when probe data of a sufficient period, or volume has not been accumulated for an area into which a probe system has been newly introduced, no reliable link travel time historical database can be generated. That is, a reliable link travel time historical database can be generated only by using a certain amount of probe data that is collected over a predetermined period (generally for several months), and after such a database is generated, a system can be practically implemented. For the reasons described above, in conventional methods no reliable link travel time historical database is generated for an area to which a probe system is newly introduced, there is the problem that the entire system cannot be quickly put into practical use even though the probe system has been activated.

As described above, the accuracy of path search and travel time estimation largely depends on the accuracy of a link travel time historical database generated by extracting a periodical change pattern of traffic situations related to a season, a day of the week, a time period, etc. from a large amount of past data. As time passes, intermediate- and long-term changes of the actual traffic situations occur depending on changes in the traffic volume. However, over time, conventional link travel time historical databases cannot accurately reflect a periodical change pattern of actual traffic situations related to a season, a day of the week, a time period, etc., and the degradation in the accuracy of path search and travel time estimation cannot be avoided. Indeed, conventional link travel time historical databases are maintained in an initial condition without update after being generated, because updating operations corresponding to the latest traffic situations are complicated and take a long time.

To improve accuracy, it is possible to manually update the historical database at predetermined time intervals, but such manual updating requires a series of operations including analyzing raw probe data, updating the link travel time historical database, cleansing unnecessary data, etc. Furthermore, while the database is in the operation of updating, the system may have to be temporarily stopped, and this is very inefficient.

To address the disadvantages discussed above, and others, it is very important for the autonomous improvement of the accuracy of the link travel time historical database to constantly consider the intermediate and long-term changes of the actual traffic situations, and to automatically update the link travel time historical database while the system is in operation.

As a related technique, the Japanese Patent Laid-Open No. 2004-178518 discloses a travel time estimating method, a travel time estimation apparatus, a travel time estimating program, and a computer-readable recording medium storing such a program.

The travel time estimation apparatus of Japanese Patent Laid-Open No. 2004-178518 includes a travel time information reception and accumulation unit, receives traffic information from a road traffic information center, and saves travel time information as chronological information about travel time in a travel time information historical database. A travel time information processing unit detects a noise component at a high frequency included in the travel time information accumulated in the travel time information historical database according to a predetermined detection condition, and removes and corrects it. The travel time estimation unit estimates a travel time according to a method of using a decision tree according to the travel time information from which the noise component has been removed and attribute information relevant to the travel time information.

On the other hand, Japanese Patent Laid-Open No. 2005-063034 discloses a traffic information estimation apparatus, a traffic information estimating method and a program.

As disclosed in Japanese Patent Laid-Open No. 2005-063034, a traffic information providing apparatus reads necessary information from a traffic information database, narrows a target link and a relevant link, and calculates a weighting coefficient of the relevant link for the target link. While considering the correlation between the target link and the relevant link closely related to the target link, the aforementioned traffic information providing apparatus calculates a retrieval distance indicating the similarity between the time travel on an estimation date and the time travel on a past date. From among plural retrieval distances, the traffic information providing apparatus selects retrieval distances for several days in the ascending order of the values, and obtains the travel hours for the target link on the estimation day using the past data on each past date.

The Japanese Patent Laid-Open No. 2005-195329 discloses a link travel time statistical data processing method, a link travel time statistical data process apparatus, and a link travel time statistical data structure.

As disclosed in Japanese Patent Laid-Open No. 2005-195329, if a link travel time c1 of an extraction target link L3 on a sample date and time is longer than a time value of a link travel time normal range τ3 of the extraction target link L3, and a link travel time d1 of a link L4 immediately subsequent to the extraction target L3 on the sample date and time is shorter than the time value of a link travel time normal range τ4 of the extraction link L4, then a difference between both link travel times c1 and d1 becomes large. Therefore, both of the link travel times c1 and d1 are removed from the link travel time historical database link travel times in the traffic information about a large number of links from a Vehicle Information and Communication System (VICS).

The Japanese Patent Laid-Open No. 2005-233815 discloses an average travel time calculation apparatus, an average link travel time calculating method, and an average link travel time data structure.

As disclosed in Japanese Patent Laid-Open No. 2005-233815, a microcomputer calculates a central value of link travel time and an average value for each link on the basis of each piece of link travel time data included in the road traffic information from a VICS and the probe information from a probe information communication system, and defines the average value of the central value of the link travel time and the average value as an average link travel time.

Furthermore, the Japanese Patent Laid-Open No. 2005-316623 discloses a travel time distribution system.

As disclosed in Japanese Patent Laid-Open No. 2005-316623, the travel time distribution system includes: a map database storing data of roads and road environments; a region travel time database storing data of travel time; and a link travel time estimation unit for accessing the map database and the region travel time database, determining the distribution of travel speeds in the region in which the travel time is provided according to the road environments, and calculating the link travel time in the region according to the distribution; and a link travel time database storing the link travel time calculated by the link travel time estimation unit.

### SUMMARY

Exemplary embodiments of the present invention overcome the above disadvantages and other disadvantages not described above. Also, the present invention is not required to overcome the disadvantages described above, and an exemplary embodiment of the present invention may not overcome any of the problems described above.

Aspects of the present invention are directed to providing an automatic update system capable of constantly maintaining a current historical database in a high accuracy status by automatically updating the history.

According to an aspect of the present invention, the automatic update system comprises: a raw data saving unit for obtaining real-time position information of a vehicle and saving the position information in a raw data storage unit; a data conversion unit for estimating a traveled road by the vehicle on a basis of the position information about the vehicle saved in the raw data storage unit at predetermined time intervals, calculating a link travel time of the vehicle, saving the link travel time of the vehicle in an intermediate result storage unit when a link speed is within predetermined range, and deleting processed position information of the vehicle from the raw data storage unit; and an historical database update unit for checking the number of data of a link travel time for each condition of a link saved in the intermediate result storage unit at a predetermined time intervals, calculating the average value of the link travel time when the number is equal to or greater than the necessary number of data for generating reliable information, updating an historical database using the average value, and deleting data used in calculating the average value from the intermediate result storage unit.

According to another aspect of the present invention, an automatic updating method comprises: (a) acquiring real-time position information of a vehicle and saving the position information in a raw data storage unit; (b) estimating a traveled road by the vehicle on a basis of the position information of the vehicle saved in the raw data storage unit at predetermined time intervals, calculating a link travel time of the vehicle, saving the link travel time of the vehicle in an intermediate result storage unit when a link speed is within the predetermined value, and deleting processed position information of the vehicle from the raw data storage unit; and (c) checking the number of data of a link travel time for each condition of a link saved in the intermediate result storage unit at a predetermined time intervals, calculating the average value of the link travel time when the number of data is equal to or greater than the necessary number of data for generating a reliable information, updating an historical database using the average value, and deleting data used in calculating the average value from the intermediate result storage unit.

According to an aspect of the present invention, the data which is continuously collected at predetermined time intervals for an initial link travel time historical database can be automatically processed, the reliability is determined, and the link travel time historical database can be automatically updated according to the latest link travel time information. In addition, it is possible to avoid the complicated operation of updating a database manually, and to maintain the database automatically. And, the accuracy of the database can be gradually and autonomously improved in accordance with intermediate- and long-term changes of actual traffic situations while operating a system. Furthermore, there is also an advantage that even in an area where a large amount of probe data has not been collected in advance, an historical database can be automatically generated while collecting raw data. So, it is possible to put a probe system into practical use quickly.

### BRIEF DESCRIPTION OF THE DRAWINGS

The aspects of the present invention will become more apparent by describing in detail exemplary embodiments thereof with reference to the accompanying drawings, in which:

FIG. 1 is a block diagram of a configuration of the automatic update system according to an exemplary embodiment of the present invention.

FIG. 2 is a flowchart of the operations of a data conversion unit according to an exemplary embodiment of the present invention.

FIG. 3 is a data format according to an exemplary embodiment of the present invention.

FIG. 4 is a flowchart showing the operations of the historical database update unit according to an exemplary embodiment of the present invention.

FIG. 5 shows a trial calculation result of an historical database according to an exemplary embodiment of the present invention when the weighting coefficient α is set to ⅓. FIG. 5(a) shows an equation for updating a link travel time historical database of this exemplary embodiment. FIG. 5(b) shows values of historical database Tᵢ. And, FIG. 5(c) shows an influence level of i period data tᵢ for historical database Tₖ after updating k period.

FIG. 6 shows a trial calculation result of an historical database according to an exemplary embodiment of the present invention when the weighting coefficient α is set to ½. FIG. 6(a) shows an equation for updating a link travel time historical database of this exemplary embodiment. FIG. 6(b) shows values of historical database Tᵢ. And, FIG. 6(c) shows an influence level of i period data tᵢ for historical database Tₖ after updating k period.

FIG. 7 is a block diagram of the configuration of another automatic update system according to an exemplary embodiment of the present invention.

### DETAILED DESCRIPTION OF EXEMPLARY EMBODIMENTS OF THE PRESENT INVENTION

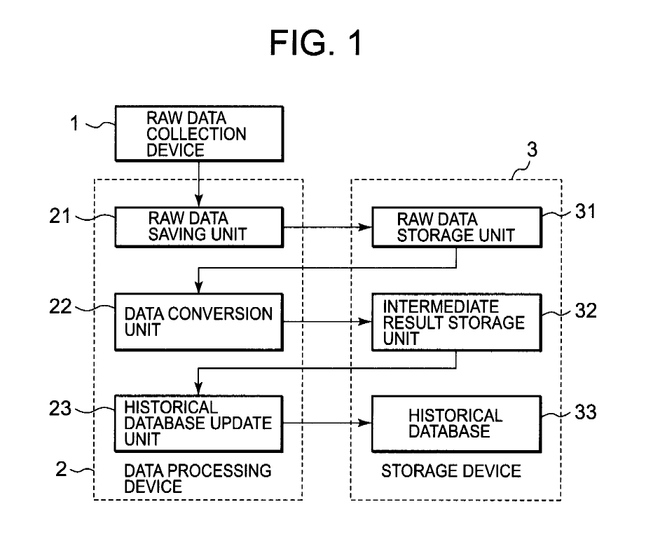

FIG. 1 shows an automatic update system according to an exemplary embodiment of the present invention. This system comprises a raw data collection device 1, a data processing device 2, and a storage device 3.

The raw data collection device 1 collects information such as the current position of a vehicle obtained by an On-Board Unit loaded into a moving vehicle. The On-Board Unit is not limited to a unit fixed to a vehicle, but may be carried into the vehicle by a user, for example.

The data processing device 2 comprises a raw data saving unit 21, a data conversion unit 22, an historical database update unit 23.

The storage device 3 comprises a raw data storage unit 31, an intermediate result storage unit 32, and an historical database 33.

The raw data saving unit 21 receives probe raw data (position information etc., of a vehicle obtained by an On-Board Unit loaded into the moving vehicle, for example) in real time from the raw data collection device 1, and saves the data in the raw data storage unit 31. The raw data storage unit 31 stores position information etc., which record the trajectories of vehicles and is collected by the raw data collection device.

The data conversion unit 22 performs map matching and detection of an abnormal value at predetermined time intervals (e.g. process starting time at 25:00 every day) by using probe raw data (e.g. from 23:00 on the second preceding day to the process starting time) in the raw data storage unit 31 as a target data.

In map matching, a road on which a vehicle is traveling is estimated using probe information. An abnormal detection is determined by comparing the travel speed of a link with a predetermined speed threshold.

The travel time depends on the stopping, bypassing, and standing-by of vehicles according to traffic, a passenger entering or exiting a vehicle, etc., are used to calculate the travel speed of a link. If it is determined that a value is abnormal, then the data is unnecessary.

Furthermore, the data conversion unit 22 saves the link travel time for only the preceding day (e.g. 0:00 to 24:00 in the preceding day) from the result calculated for the link travel time of each time period in the intermediate result storage unit 32. And, the data conversion unit 22 deletes the probe raw data up to predetermined time (e.g. 23:00) of the preceding day that has been processed by the raw data storage unit 31. At this time, the actually traveled road is estimated from each piece of vehicle travel trajectory data, and the intermediate result storage unit 32 stores the travel time actually taken for each traveled road link.

The historical database update unit 23 checks the number of pieces of link travel time data for each season, day of the week, and time period that are saved in the intermediate result storage unit 32 for each link at predetermined time intervals (e.g. process starting time is 25:00 every day). And, the historical database update unit 23 calculates the average value of link travel time when the number is equal to, or greater than, a predetermined number of pieces of data that is necessary for generating reliable information, and updates the historical database 33 using the average value. Then, the historical database update unit 23 deletes the data used in calculating the average value from the intermediate result storage unit 32. The historical database 33 stores the link travel time for each season, day of the week, and time period, and is automatically updated with the data of the intermediate result storage unit 32 with the lapse of the system operation time. On the other hand, if the data number for each season, day of the week, and time period of the link in the intermediate result storage unit 32 is lower than the necessary data numbered, then the data is saved as is, and re-processed together with subsequent data.

Practically, the link travel time of the historical database 33 is updated by the following equation:
Tᵢ=αtᵢ+(1−α)Tᵢ₋₁

where Tᵢ indicates the link travel time in a period i after the storage device 33 has been updated; a indicates a weighting coefficient (0≦α≦1) (as α becomes larger, the updated historical database 33 is more affected by new data); tᵢ indicates the average link travel time in period i calculated from the data of the intermediate result storage unit 32; and Tᵢ₋₁ indicates the un-updated link travel time in historical database 33 in the period i (when i is 1, it is an initial historical database); and.

Next, by way of illustration, the operation of automatically updating the link travel time historical database is described practically by using the data of a certain day (e.g. Tuesday).

The raw data saving unit 21 receives real-time probe raw data from the raw data collection device 1, and saves the data in the raw data storage unit 31. For example, the time windows for this process can typically set as 5 minutes.

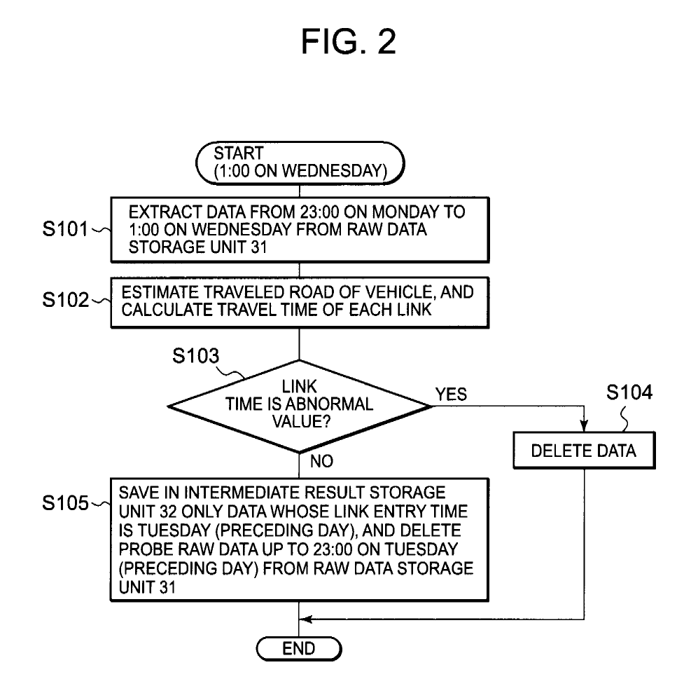

FIG. 2 shows an exemplary operation of the data conversion unit 22. The operation is as follows:

(1) Operation S101:

The data conversion unit 22 extracts the data from 23:00 on Monday to the current time (1:00 on Wednesday) from the raw data storage unit 31 at 1:00 on Wednesday, the following day.

(2) Operation S102:

The road traveled by a vehicle is estimated using the extracted data and the travel time of each link is calculated.

(3) Operation S103:

The process of detecting an abnormal value is performed by comparing the travel speed of a link with a predetermined speed threshold.

(4) Operation S104:

If a link time is an abnormal value, then such abnormal data is deleted.

(5) Operation S105:

If the link time is not an abnormal value, only the data whose link entry time is Tuesday (previous day), from among the non-abnormal data is saved in the intermediate result storage unit 32. And, the processed probe raw data up to 23:00 on Tuesday (previous day) is deleted from the raw data storage unit 31.

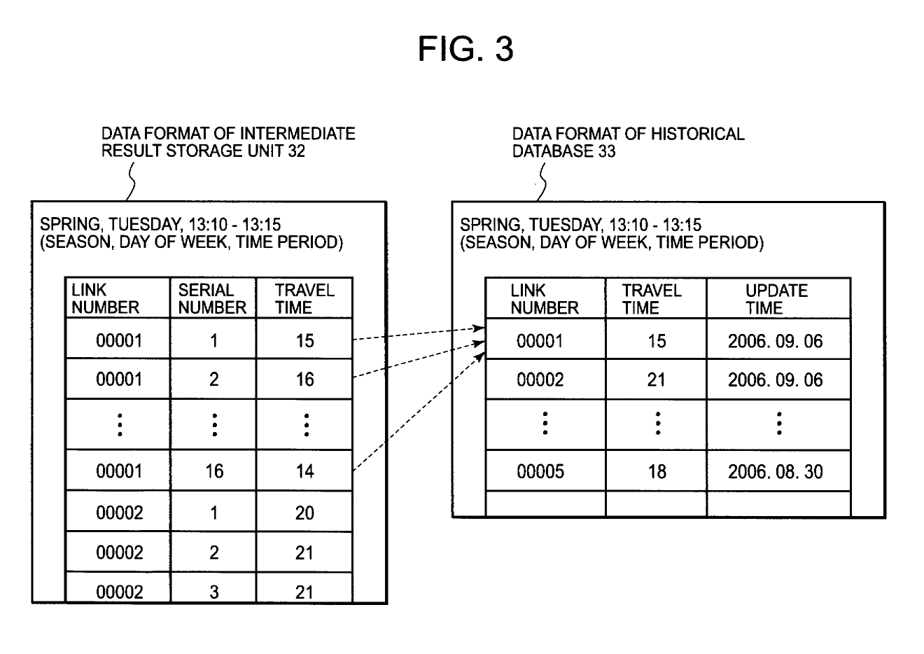

As shown in FIG. 3, since there can be several travel time data from different vehicles in the same time period, regarding the same link, the intermediate result storage unit 32 includes the number of link travel time records for the same season, day of the week, and time period unlike the link travel time historical database 33.

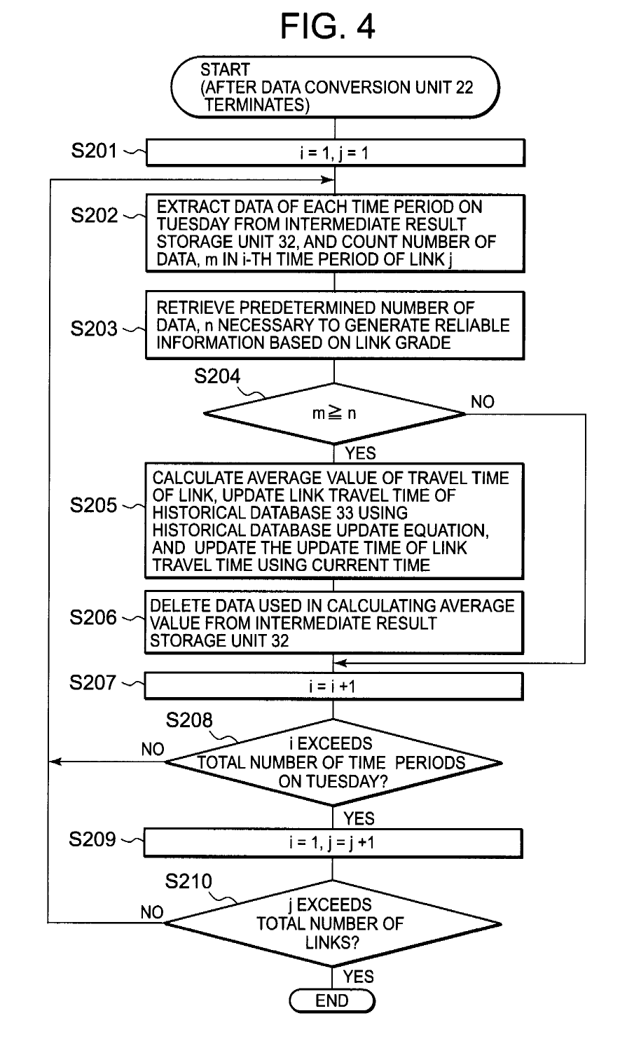

FIG. 4 shows an exemplary operation of the historical database update unit 23.

The historical database update unit 23 starts its operation after the process of the data conversion unit 22 terminates. First, the historical database update unit 23 checks the number of pieces of data saved in the intermediate result storage unit 32, for each link, in each time period, on Tuesday (in this example), and compares the number with the predetermined number (e.g. 10) of pieces of data necessary to generate reliable information. When the number is equal to, or greater than, the predetermined necessary date number, the historical database update unit 23 calculates the average value of the travel time of the link, and updates the link travel time of the historical database 33 and the update time of the link travel time using the average value and the current time, respectively. And, the historical database update unit 23 deletes the data used in calculating the average value from the intermediate result storage unit 32. If the data number of each season, day of the week, and time period for a link of the intermediate result storage unit 32 is lower than the predetermined necessary data number, then the data is saved as is, and the above-mentioned process of determining the data number is performed again including the subsequent data. According to this exemplary embodiment, after the data for each time period on Tuesday for all links is processed, the operation of the historical database update unit 23 terminates.

Described in detail below is an exemplary operation of the historical database update unit 23, with reference to FIG. 4.

(1) Operation S201:

After the data conversion unit 22 terminates, the historical database update unit 23 first sets the values of variables i and j to 1 (i=1, j=1).

(2) Operation S202:

Data for each time period on Tuesday (the day Tuesday is employed here merely as an example and on of ordinary skill in the art will readily understand that the present invention is not limited thereto) is extracted from the intermediate result storage unit 32, and the number of data, m in the i-th time period of the link j is counted.

(3) Operation S203:

Depending on the link grade, the predetermined number of data, n, that is necessary to generate reliable information are retrieved.

(4) Operation S204:

The number of data, m in the i-th time period of the link j is compared with n.

(5) Operation S205:

When the number of data, m is equal to or greater than n, the average value of the travel time of the link j is calculated, and the link travel time of the historical database 33 is updated using the historical database update equation. And then, the update time of the link travel time is updated on the using the current time.

(6) Operation S206:

The data used in calculating the average value is deleted from the intermediate result storage unit 32.

(7) Operation S207:

The value 1 is added (incremented) to the value of i (i=i+1). As shown in FIG. 4, this same operation is performed when the number of data, m is lower than the necessary number of data, n.

(8) Operation S208:

It is determined whether or not the value of i has exceeded the total number of time periods. If not, the process continues again from the operation of counting the number of data m in the i-th time period of the link j.

(9) Operation S209:

If the value of i has exceeded the total number of time periods, then the value of i is returned to the value 1 (i=1), and the value 1 is added (incremented) to the value of j (j=j+1).

(10) Operation S210:

It is determined whether or not the link j has exceeded the total number of links. If yes, then the operation of the historical database update unit 23 terminates. If not, then the process continues again from the operation of counting the number of data, m in the i-th time period of the link j.

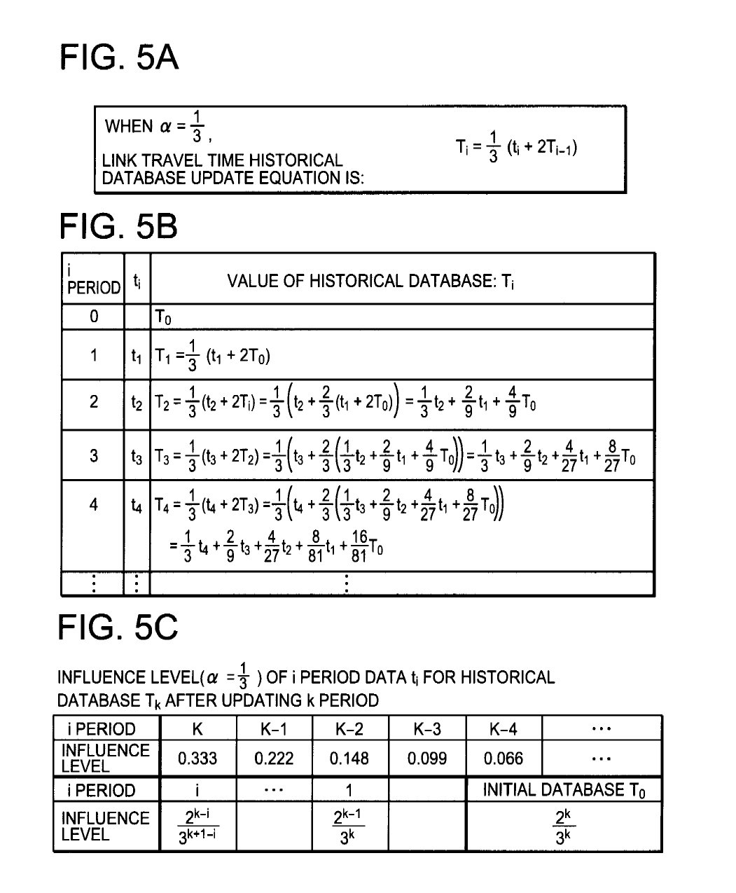

An example of a trial calculation result of the link travel time historical database is shown in FIG. 5. According to the exemplary embodiment shown in FIG. 5, the weighting coefficient α of the historical database update equation is set to ⅓ (this is merely an example, and the value of α may be somewhat lower).

FIG. 5(a) shows an equation for updating a link travel time historical database in this exemplary embodiment. FIG. 5(b) shows values of historical database Tᵢ. And, FIG. 5(c) shows an influence level of i period data tᵢ for historical database Tₖ after updating k period.

According to the exemplary embodiment shown in FIGS. 5(a), 5(b) and 5(c), the link travel time historical database is organized for each season, day of the week, and time period. Further, as shown in FIGS. 5(a), 5(b) and 5(c), the data of one period before refers to the data of at least one week before for a certain link (i.e., data in the same time period on the same day of the week). If the link travel time historical database is updated every period, then the influence level of the four periods before (about one month) is 0.066, and cannot be completely ignored. The influence level of the initial historical database maintains 0.132. When the weighting coefficient α is low, it indicates that the past data is valued highly. Therefore, such a low weighting coefficient α is applied when the initially generated historical database is prepared with a sufficient number of pieces of data and the reliability of the data is high, and when a long-term change of traffic situations is not rapid.

If the reliability of the initial link travel time historical database is not sufficient (for example, in an area in which a probe system is newly implemented, or when the amount of data for generating an initial historical database is low), or if a change of traffic situations is rapid, then the result of the updated historical database is more strongly affected by the current information by setting a larger weighting coefficient α, thereby more closely reflecting the current information of the link travel time historical database.

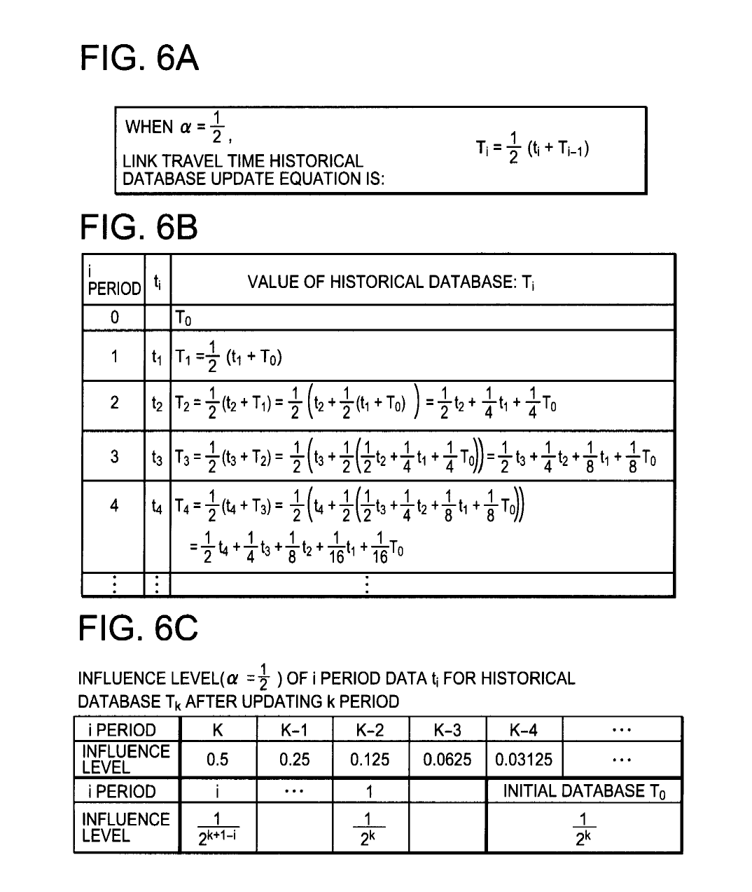

FIGS. 6(a), 6(b) and 6(c) show an example result of a trial calculation of the link travel time historical database when the weighting coefficient α of the historical database update equation is set to ½ (somewhat higher than the exemplary embodiment shown in FIGS. 5(a), 5(b) and 5(c)), according to another exemplary embodiment of the present invention.

FIG. 6(a) shows an equation for update a link travel time historical database according to an exemplary embodiment of the present invention. FIG. 6(b) shows values of an historical database Tᵢ. And, FIG. 6(c) shows an influence level of i period data tᵢ for an historical database Tₖ after updating k period.

If the link travel time historical database is organized for each season, day of the week, and time period, and if the link travel time historical database is updated every period, and a period equals one week, then the influence level of the data in four periods before (about a month before), and the influence of the initial historical database on the updated link travel time historical database is only 0.03125 which is an ignorable level. That is, the initial value of the link travel time historical database will almost be switched after four weeks.

Described below is another exemplary embodiment of the present invention.

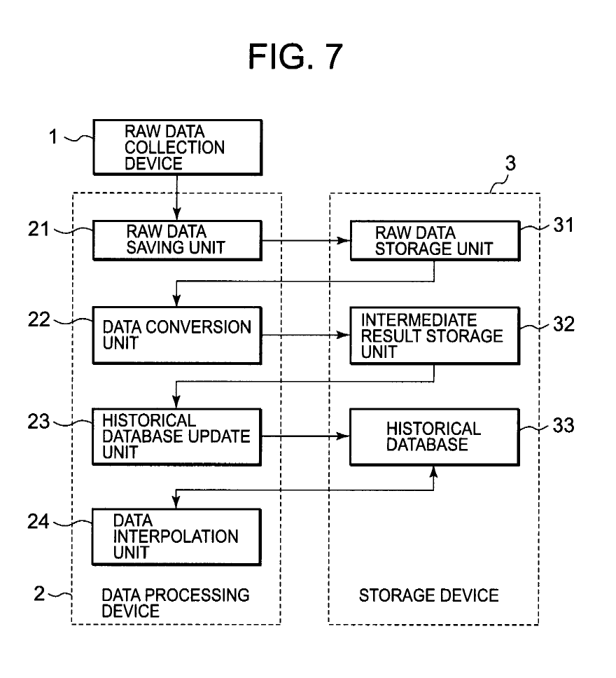

The historical database 33 is updated with the system configuration shown in FIG. 1. However, the amount of data for each time period of a certain link of the intermediate result storage unit 32 depends on the actual collection situations of the probe data collected by the raw data collection device 1. For this reason, there can be a time period whose travel time is frequently updated, and meanwhile, there can be a time period whose travel time is rarely updated for a respective link of the historical database 33. If the update time of the link travel time is older than a predetermined threshold (30 days, for example) from the current time, it is preferable, but not necessary, to perform a re-calculation (interpolation) depending on the travel time in an adjacent time periods. This is because the continuity of the travel time of each links should be taken into account. FIG. 7 shows a system according such an exemplary embodiment.

As shown in FIG. 7, the automatic update system according to this exemplary embodiment of the present invention comprises the raw data collection device 1, the data processing device 2 operating by program control, and the storage device 3 storing information as with the configuration shown in FIG. 1. And in the exemplary configuration shown in FIG. 7, the data processing device 2 comprises the raw data saving unit 21, the data conversion unit 22, the historical database update unit 23, and a data interpolation unit 24. That is, as compared with the exemplary embodiment of the present invention shown in FIG. 1, a difference is that the exemplary data processing device 2 shown in FIGS. 5(a), 5(b) and 5(c) further comprises the data interpolation unit 24.

The data interpolation unit 24 determines a target to be interpolated and performs an interpolating process. If the update time of the link travel time is older than a predetermined threshold (30 days, for example) from the current time, then it is determined that the link travel time for the time period is to be re-calculated and that the time period is to be interpolated. On the other hand, if the update time of the link travel time is more recent than the threshold, then it is determined that the data for the link travel time is new. An interpolating method is, for example: if the travel times in the preceding and subsequent time periods adjacent to the time period having been interpolated are new, then the interpolating process is performed using the average value of the both travel times of those time periods. If the travel time in either the preceding or subsequent time period is new, then the interpolating process is performed using that new travel time. If the travel times in both adjacent preceding and subsequent time periods are not new, then the data is not updated and the interpolating process is not performed. The “preceding and subsequent time periods” may be, for example, the time periods before and after the time period to be interpolated, the same time periods of the previous and subsequent days, the same time periods of the links adjacent to the target link, etc.

The present invention may be applied, for example, when a road traffic information service such as travel time estimation, path search, etc. is provided using basic situations (periodic fluctuation pattern) for a road link or a road section.

In addition, the present invention may be applied, for example, when it is necessary to automatically update a basic information database regarding an attribute using intermediate and long-term change of the attribute.

Several characteristics of the exemplary embodiments of the present invention are described below.

(1) To maintain and improve the accuracy of a link travel time historical database describing the basic situations of a link travel time, the influence of intermediate and long-term change of traffic volume is constantly considered, and new changes are continuously incorporated, thereby amending the database.

(2) By automatically and periodically executing a program, a complicated manual updating operation can be avoided, and a link travel time historical database can be easily updated.

(3) By using new data only after confirming the reliability of the new data, before updating an historical database, data cannot be used unless it satisfies a reliability standard with next collected data and, thus, use of lower reliability data is avoided.

(4) The weighting coefficient α for updating an historical database is adjusted based on the reliability of an initial link travel time historical database and the rapidness of a change of the actual traffic situations.

(5) Taking into account a continuity of the time period fluctuation of travel time, a time period having an old link travel time value is updated by using a new value of an adjacent time period of the same link.

As described above, the automatic update system for a road link travel time historical database according to exemplary embodiments of the present invention can constantly and automatically obtain a long-term change of road traffic situations, which resulted from changes in road traffic volume etc., accompanying the development of social economy. Exemplary embodiments of the present invention can also continuously enhance the accuracy of a road link travel time historical database required for road travel time estimation and path search with continuously collected probe raw data (e.g., position information etc., of a vehicle got by on-Board Unit loaded in the vehicle).

While exemplary embodiments of the present invention have been described above, it is to be understood that numerous modifications to the exemplary embodiments of the invention will be apparent to those skilled in the art without departing from the spirit and scope of the present invention as defined in the following claims.

What is claimed is:

1. An automatic update system, comprising:
a raw data saving unit which obtains position information of a vehicle and saves said position information in a raw data storage unit;
a data conversion unit which calculates a link travel time of said vehicle and saves said link travel time in an intermediate result storage unit; and
an historical database update unit which checks a number of data regarding said link travel time that are saved in said intermediate result storage unit, calculates an average value of said link travel time when said number of data is equal to or greater than a predetermined number of data, and updates a link travel time of an historical database using said average value.

2. The automatic update system according to claim 1, wherein said link travel time of said historical database is updated using an equation below:
Tᵢ=αtᵢ+(1−α)Tᵢ₋₁;
wherein Tᵢ is an updated link travel time;
wherein α is a weighting coefficient;
wherein tᵢ is an average link travel time at a period i; and
wherein Tᵢ₋₁ is a link travel time before updating at a period i.

3. The automatic update system according to claim 1, wherein said data conversion unit estimates a road traveled by said vehicle using said position information of said vehicle.

4. The automatic update system according to claim 2, wherein said historical database update unit determines said weighting coefficient α using a reliability of said historical database and a frequency of change of a traffic situation.

5. The automatic update system according to claim 1, further comprising:
a data interpolation unit which determines whether it is necessary to re-calculate a link travel time for a time period if said link travel time was updated more than a predetermined time ago.

6. The automatic update system according to claim 5, wherein said data interpolation unit performs interpolation by using an average value of travel times of two adjacent time periods if said travel times of said two adjacent time periods have both been updated more recently than a predetermined value.

7. The automatic update system according to claim 5, wherein said data interpolation unit performs interpolation by using a travel time of one of two adjacent time periods when a travel time of the other adjacent time period has not been updated recently.

8. Au automatic updating method, comprising:
obtaining position information of a vehicle;
saving said position information in a raw data storage unit;
calculating a link travel time of said vehicle;
checking a number of data for said link travel time;
calculating an average value of said link travel time;
updating an historical database by using said average value.

9. The automatic updating method according to claim 8, wherein said calculating a link travel time of said vehicle comprises:
extracting data of said position information of said vehicle for a predetermined period from said raw data storage unit;
estimating a road traveled by said vehicle from said extracted data
calculating a travel time of a traveled link;
detecting an abnormal value by comparing a travel speed of said link with a predetermined speed;
deleting said abnormal value; and
saving non-abnormal data in an intermediate result storage unit.

10. The automatic updating method according to claim 9, wherein said checking the number of data of said link travel time comprises:
extracting data for each time period from said intermediate result storage unit;
counting a number of data m which is for a time period of said traveled link;
comparing said number of data m with a predetermined number of data n; and
calculating an average value of travel time of said traveled link if m is equal to or greater than n.

11. The automatic updating method according to claim 8, wherein updating an historical database by using said average value is performed using an equation below:
Tᵢ=αtᵢ+(1−α)Tᵢ₋₁;
wherein Tᵢ is an updated link travel time;
wherein α is a weighting coefficient;
wherein tᵢ is an average link travel time at a period i; and
wherein Tᵢ₋₁ is a link travel time before updating at a period i.

12. The automatic updating method according to claim 8, further comprising:
determining whether it is necessary to re-calculate a link travel time for a time period if said link travel time was updated more than a predetermined time ago.

13. The automatic updating method according to claim 12, further comprising:
performing interpolation by using an average value of travel times of two adjacent time periods if said travel times of said two adjacent time periods have both been updated more recently than a predetermined value.

14. The automatic updating method according to claim 12, further comprising:
performing interpolation by using a travel time of one of two adjacent time periods when a travel time of the other adjacent time period has not been updated recently.

15. A computer readable storage medium comprising instructions for causing a computer to execute the automatic updating method according to claim 8.
